(19) United States
(12) Patent Application Publication
(10) Pub. No.: US 2008/0221912 A1
(43) Pub. Date: Sep. 11, 2008

(54) Submarine Patents

(76) Inventor: David James Harris, Birmingham (GB)

Correspondence Address: David James Harris, 1 Station Road, Shenstone, Lichfield, WS14 0NW, GB

(21) Appl. No.: 11/684,621

(22) Filed: Mar. 11, 2007

(51) Int. Cl. G06Q 30/00

(52) U.S. Cl. 705/1

(57) ABSTRACT

A method of seeking patent protection for an invention, comprising:
a) filing a first European Patent Application for the invention at a first date;
b) filing a second European Patent Application for the invention at a second date not more than one month later;
   characterised in that the second European Patent Application is a divisional European Patent Application claiming the filing date of the first European patent application. The method may further include the step of filing further European Patent Applications at intervals of not more than one month, each further European Patent Application being a divisional European Patent Application claiming the date of the previous European Patent Application. Each of the further European Patent Applications save the latest filed may be allowed to lapse one month after filing due to non-payment of the filing and search fees.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention relates to submarine patents and methods for filing and prosecuting the same.

Patents are well known in the prior art and provide a monopoly for an invention for a period of time, generally 20 years, in exchange for an ‘enabling’ disclosure of the invention. One popular patent-granting regime is that of the European Patent Convention (EPC) under which European Patents are granted by the European Patent Office (EPO).

However, due to reasons of commercial sensitivity, it is often desired to keep one's inventions secret for as long as possible. Patents, particularly those filed with the EPO, are generally granted about 18 months after the first filing for the invention. This publication is, as the name suggests, public and applicants for patents may wish to avoid or delay publication in order to gain a commercial advantage. It would be particularly advantageous to delay publication until a time when it is know by the applicant that they wish to enforce their patent rights. These have become known as “submarine” patent applications.

Furthermore, filing applications, particularly European Patent Applications, involves the payment of heavy filing and search fees and some, particularly impecunious, applicants would like to avoid this.

It is an object of this invention to ameliorate some of the problems with the prior art.

2. Description of Related Art

Not Applicable

### BRIEF SUMMARY OF THE INVENTION

According to the first aspect of the invention, there is provided a method of seeking patent protection for an invention, comprising:
a) filing a first European Patent Application for the invention at a first date;
b) filing a second European Patent Application for the invention at a second date not more than one month later;
   characterised in that the second European Patent Application is a divisional European Patent Application claiming the filing date of the first European patent application.

This allows the first European Patent Application to lapse without payment of the filing and search fees. Indeed, in a preferred embodiment of the invention, the first European Patent Application is allowed to lapse by non-payment of the filing or search fees.

The method may further include the step of filing further European Patent Applications at intervals of not more than one month, each further European Patent Application being a divisional European Patent Application claiming the date of the previous European Patent Application. Each of the further European Patent Applications save the latest filed may be allowed to lapse one month after filing due to non-payment of the filing and search fees.

This process allows payment of any of the filing and search fees due on any of the European Patent Applications to be delayed until the applicant sees fit. Furthermore, the likelihood of the European Patent Office publishing any of the European Patent Applications whilst the filing and search fees have been paid is minimal. The applicant may therefore delay publication and the payment of the filing and search fees until an arbitary date (within twenty years of the filing date of the first European Patent Application).

The method may include the step of initially filing a priority application not more than a year before the first European Patent Application, and claiming for the first European Patent Application the priority date thereof. The priority application may be filed for any state party to the Paris Convention on Intellectual Property. It may be a United Kingdom Patent Application.

### BRIEF DESCRIPTION OF THE SEVERAL VIEWS OF THE DRAWING

FIG. 1 shows a flow chart showing the operation of an embodiment of the invention.

### DETAILED DESCRIPTION OF THE INVENTION

There now follows by way of example, a description of an embodiment of the invention.

Once an inventor has invented an invention, they, or their employer, will generally pass responsibility to protecting the invention to a patent attorney or agent. They will draft a specification generally in line with this document, comprising an introduction describing the background to the invention, statements of the invention describing in broad terms the invention and one or more specific embodiments describing in detail how to carry out the invention. The specification may also contain one or more claims defining the protection sought by the prospective patent application, and an abstract of the invention.

The patent application may then be filed at a patent office. The Paris Convention priority period of one year may be used at this point by filing an application patent (say at the United Kingdom Patent Office) and then waiting a year before taking any further action; any later filed applications should then claim the priority of this application. A search of the application may also be performed in order to discover any relevant prior art.

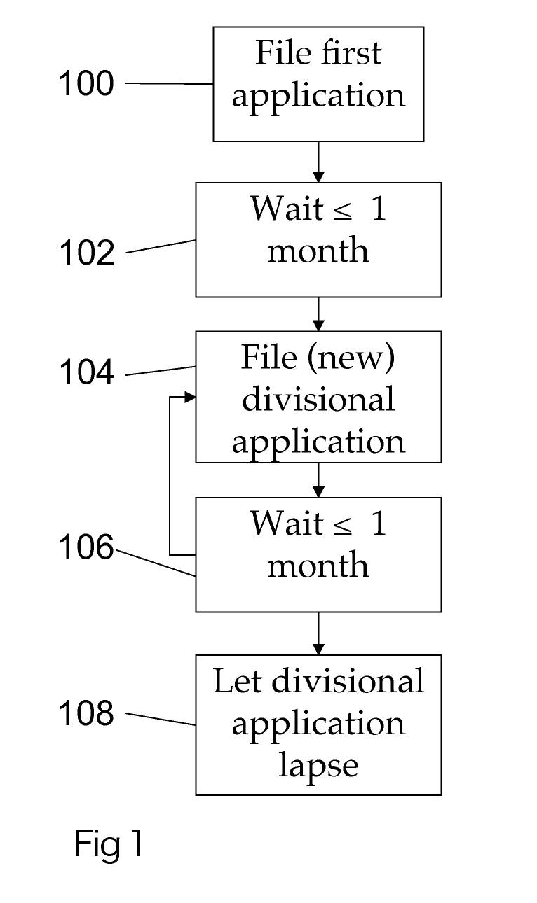

Within this year, or as a first filing, a European Patent Application may be filed (step 100 in FIG. 1) either direct with an EPO filing office (The Hague, Berlin or Munich) or with a competent national authority under Article 75(b) EPC. Any national security restrictions, such as a compulsion to file at such a national office, should be followed. Notification of the application number will follow in due course.

Filing the European Patent application sets a time limit of one month for paying the search and filing fees (step 102). If the fees are not paid in due time, the application will lapse at the end of this period of a month from filing. However, a European Divisional Application (under Article 76 EPC) identical to the first application may be filed in this month (step 104). The filing and search fees become due on the divisional application one month after filing, which provides an extra period equivalent to the period expired between filing of the previous application with the present divisional application (step 106). The previous application may then be allowed to lapse (step 108) with no loss of rights.

The process of filing substantially identical divisional applications within the period of a month for paying the filing and search fees on the latest application may then be carried on as long as the applicant wishes. The EPO are unlikely to publish any application on which no filing and search fees have been paid and so the description may remain unpublished for as long as the applicant wishes.

When the applicant wishes to have the latest application searched and published, they may simply pay the filing and search fees. They will also need to pay any back-renewal fees due if more than two years have passed since the original European filing date.

1. A method of seeking patent protection for an invention, comprising:
a) filing a first European Patent Application for the invention at a first date;
b) filing a second European Patent Application for the invention at a second date not more than one month later;
characterised in that the second European Patent Application is a divisional European Patent Application claiming the filing date of the first European patent application.

2. The method of claim 1 in which the first European Patent Application is allowed to lapse by non-payment of the filing or search fees.

3. The method of claim 1 further including the step of filing further European Patent Applications at intervals of not more than one month, each further European Patent Application being a divisional European Patent Application claiming the date of the previous European Patent Application.

4. The method of claim 3 in which each of the further European Patent Applications save the latest filed are allowed to lapse one month after filing due to non-payment of the filing and search fees.

5. The method of claim 1 further including the step of initially filing a priority application not more than a year before the first European Patent Application, and claiming for the first European Patent Application the priority thereof.
